(19) United States
(12) Patent Application Publication
(10) Pub. No.: US 2012/0286735 A1
(43) Pub. Date: Nov. 15, 2012

(54) ENERGY STORAGE MODULE AND CONTROLLING METHOD THEREOF

(75) Inventors: Young Hak JEONG, Gyeonggi-do (KR); Hong Seok MIN, Gyeonggi-do (KR); Bae Kyun KIM, Gyeonggi-do (KR); Chan YOON, Seoul (KR)

(73) Assignee: SAMSUNG ELECTRO-MECHANICS CO., LTD.

(21) Appl. No.: 13/443,666

(22) Filed: Apr. 10, 2012

(30) Foreign Application Priority Data
May 11, 2011 (KR) 10-2011-0044035

(51) Int. Cl. H02J 7/00

(52) U.S. Cl. 320/126; 320/167

(57) ABSTRACT

Disclosed herein is an energy storage module including a first energy container, a second energy container that is connected to the first energy container in parallel, and a switching control unit that senses the energy containers corresponding to predetermined deterioration conditions among the first and second energy containers to selectively open the energy containers corresponding to deterioration conditions so as to selectively charge/discharge the energy containers, whereby the deterioration can be minimized without stopping the overall energy storage module.

### CROSS REFERENCE(S) TO RELATED APPLICATIONS

This application claims the benefit under 35 U.S.C. Section 119 of Korean Patent Application Serial No. 10-2011-0044035, entitled “Energy Storage Module and Controlling Method thereof” filed on May 11, 2011, which is hereby incorporated by reference in its entirety into this application.

### BACKGROUND OF THE INVENTION

1. Technical Field

The present invention relates to an energy storage module and a controlling method thereof, and more particularly, to an energy storage module and a controlling method thereof capable of performing charging/discharging using a plurality of energy containers that are connected to each other in series.

2. Description of the Related Art

The stable supply of energy is an important factor in various electronic products such as information communication devices. Generally, this function is performed by a battery. Recently, as the spread of mobile devices is increased, the use of a secondary battery capable of supplying energy to the mobile devices by repeating charging/discharging several thousand times or tens of thousand times has increased.

Meanwhile, a representative example of the secondary battery may include a lithium ion secondary battery. The lithium ion secondary battery can be manufactured smaller and lighter and can stably supply power for a long period of time, due to high energy density; however, may reduce instant output and require long charging time due to low power density and shorten lifespan by several thousand times due to the charging/discharging.

In order to supplement the disadvantages of the lithium ion secondary battery, a device called an ultracapacitor or a supercapacitor that has recently been developed is in the limelight as the next-generation energy storage device due to a rapid charging/discharging rate, high stability, and environmentally friendly characteristics.

The ultracapacitor or the supercapacitor has lower energy density than the lithium ion secondary battery, but has power density several ten to several hundred times higher and charging/discharging lifespan several hundreds of thousand times longer than the lithium ions secondary battery and has the rapid charging/discharging rate enough to implement complete charging in several seconds.

The above-mentioned secondary battery and capacitors are energy containers. The energy container sensitively responds to temperature and as a result, the deterioration thereof may be accelerated when the energy container is continuously maintained at high temperature or low temperature.

Therefore, a need exists for a method for minimizing the deterioration in the energy container.

### SUMMARY OF THE INVENTION

An object of the present invention is to provide an energy storage module and a controlling method thereof capable of minimizing deterioration without stopping the overall energy storage module by connecting a plurality of energy containers in parallel and selectively charging/discharging the energy container by selectively opening the energy containers corresponding to deterioration conditions.

According to an exemplary embodiment of the present invention, there is provided an energy storage module, including: a first energy container; a second energy container that is connected to the first energy container in parallel; and a switching control unit that senses the energy containers corresponding to predetermined deterioration conditions among the first and second energy containers to selectively open the energy containers corresponding to deterioration conditions so as to selectively charge/discharge the energy containers.

The deterioration conditions may include first and second deterioration conditions sequentially set according to temperature.

The deterioration conditions may include first and second deterioration conditions sequentially set according to voltage.

The deterioration conditions may include first and second deterioration conditions sequentially set according to a frequency of charging/discharging.

The switching control unit may sense the first energy container corresponding to the first deterioration condition among the first and second energy containers to open the first energy container corresponding to the first deterioration condition and connect the second energy container.

The switching control unit may sense whether the second energy container corresponds to the second deterioration condition and if it is determined that the second energy container corresponds to the second deterioration condition, open the second energy container and connects the first energy container.

The switching control unit may connect both of the first and second energy containers if it is determined that the first and second energy containers do not correspond to the deterioration conditions.

The first deterioration condition may be a first reference temperature that is a minimum temperature for sensing the deterioration and the second deterioration condition may be a second reference temperature that is a maximum temperature not causing the deterioration.

The switching control unit may include: a first switch that is connected to the first energy container in series; and a second switch that is connected to the second energy container in series.

The switching control unit may include a controller that senses the energy container corresponding to the deterioration conditions among the first and second energy containers and output a control signal for selectively opening the energy container corresponding to the deterioration conditions.

The first energy container may be configured in at least one that is connected in series. The second energy container may be connected to the first energy container in parallel and may be configured in at least one.

According to another exemplary embodiment of the present invention, there is provided a controlling method of an energy storage module including a first energy container and a second energy container connected to the first energy container in parallel, including: sensing the energy container corresponding to predetermined determination conditions among the first and second energy containers that perform charging/discharging; and selectively opening the energy container corresponding to the deterioration conditions so as to selectively charge/discharge the energy containers.

The deterioration conditions may include first and second deterioration conditions sequentially set according to temperature.

The sensing may include a first sensing step that senses the first energy container corresponding to the first deterioration conditions among the first and second energy containers and the opening may include a first opening step that opens the first energy container corresponding to the first deterioration condition and connects the second energy container.

The sensing may further include a second sensing step that senses whether the second energy container corresponds to the second deterioration condition and the opening may further include a second opening step that opens the second energy container and connects the first energy container if it is determined that the second energy container corresponds to the second deterioration condition.

The controlling method of an energy storage module may further include connecting both of the first and second energy containers if it is determined that the first and second energy containers do not correspond to the deterioration conditions.

### BRIEF DESCRIPTION OF THE DRAWINGS

FIG. 1 is a configuration diagram of an energy storage module according to an exemplary embodiment of the present invention;

FIGS. 2 and 3 are diagrams for explaining an operation of a switch for selectively opening energy containers corresponding to deterioration conditions in an energy storage module according to the exemplary embodiment of the present invention; and

FIG. 4 is an operational flow chart for explaining a process of controlling an energy storage module according to the exemplary embodiment of the present invention.

### DESCRIPTION OF THE PREFERRED EMBODIMENTS

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe most appropriately the best method he or she knows for carrying out the invention

Therefore, the configurations described in the embodiments and drawings of the present invention are merely most preferable embodiments but do not represent all of the technical spirit of the present invention. Thus, the present invention should be construed as including all the changes, equivalents, and substitutions included in the spirit and scope of the present invention at the time of filing this application.

Hereinafter, exemplary embodiments of the present invention will be described in detail with reference to the accompanying drawings.

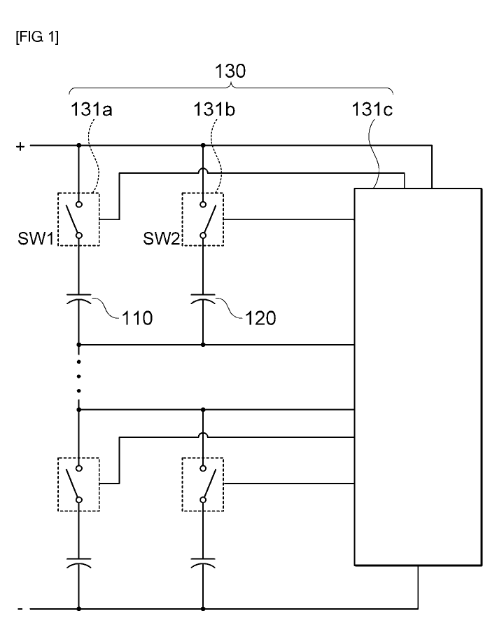

FIG. 1 is a configuration diagram of an energy storage module according to an exemplary embodiment of the present invention.

As shown in FIG. 1, an energy storage module 100 is configured to include a first energy container 110, a second energy container 120, and a switching control unit 130.

The first energy container 110 may be configured in at least one. Generally, a plurality of first energy containers 110 is connected in series in order to obtain high voltage. As the first energy container 110, a secondary battery, an ultracapacitor, and a supercapacitor may be used and other energy containers having characteristics similar thereto may be used.

The second energy container 120 is connected to the first energy container 110 in parallel and may be configured in at least one. The second energy container 120 means the energy container having the same characteristics as the first energy container 110 configuring the energy storage module 100.

Both of the first and second energy containers 110 and 120 are configured to perform charging/discharging while maintaining a normal connection state but selectively open the energy container corresponding to the deterioration conditions so as to minimize deterioration.

Describing in more detail, the switching control unit 130 is a unit that senses the energy container corresponding to the predetermined deterioration conditions among the first and second energy containers 110 and 120 to selectively open the energy container corresponding to the deterioration conditions so as to selectively charge/discharge the energy container and is configured to include a first switch 131a, a second switch 131b, and a controller 131c.

The first switch 131a (SW1) is connected to the first energy container 110 in series to open or connect the first energy container 110.

Describing in more detail, when the first switch 131a is applied with an on control signal from the controller 131c, the first switch 131a is turned-on to connect the first energy container 110 and when the first switch 131a is applied with an off control signal from the controller 131c, the first switch 131a is turned-off to open the first energy container 110.

The second switch 131b (SW2) is connected to the second energy container 120 in series to open or connect the second energy container 120.

Describing in more detail, when the second switch 131b is applied with an on control signal from the controller 131c, the second switch 131b is turned-on to connect the second energy container 120 and when the second switch 131b is applied with an off control signal from the controller 131c, the second switch 131b is turned-off to open the second energy container 120.

The first and second switches 131a and 131b may be configured of a bipolar junction transistor (BJT), an insulated gate bipolar transistor (IGBT), a metal-oxide-semiconductor field effect transistor (MOSFET), or the like.

The controller 131c senses the state (for example, temperature, voltage, and frequency of charging/discharging, or the like) of the first and second energy containers 110 and 120 and uses the state of the sensed first and second energy containers 110 and 120 so as to sense the energy container corresponding to the deterioration conditions.

In this case, the deterioration conditions may include first and second deterioration conditions that are sequentially set according to temperature.

Further, the deterioration conditions may include first and second deterioration conditions that are sequentially set according to voltage and may include first and second deterioration conditions that are sequentially set according to the frequency of charging and discharging.

For example, when the deterioration conditions include the first and second deterioration conditions sequentially set according to temperature, the controller 131c may sense the energy container reaching the first deterioration condition, that is, a first reference temperature among the first and second energy containers 110 and 120. Further, when the deterioration conditions include the first and second deterioration conditions sequentially set according to voltage, the controller 131c may sense the energy container reaching the first deterioration condition, that is, a first reference voltage among the first and second energy containers 110 and 120 and when the deterioration conditions include the first and second deterioration conditions sequentially set according to the frequency of charging and discharging, the controller 131c may sense the energy container reaching the first deterioration condition, that is, the frequency of first reference charging/discharging among the first and second energy containers.

Further, the controller 131c performs a control to open the first energy container 110 corresponding to the first deterioration condition and connect the second energy container 120 by sensing the first energy container 110 corresponding to the first deterioration condition among the first and second energy containers 110 and 120. Since the charging/discharging is performed only in the second energy container 120 by the operation of the controller 131c, the deterioration in the first energy container 120 may be minimized.

Further, the controller 131c senses whether the second energy container 120 corresponds to the second deterioration condition. If it is determined that the second energy container 120 corresponds to the second deterioration condition, the controller 131c opens the second energy container 120 and connects the first energy container 110. Since the charging/discharging is performed only in the first energy container 110 by the operation of the controller 131c, the deterioration in the second energy container 110 may be minimized.

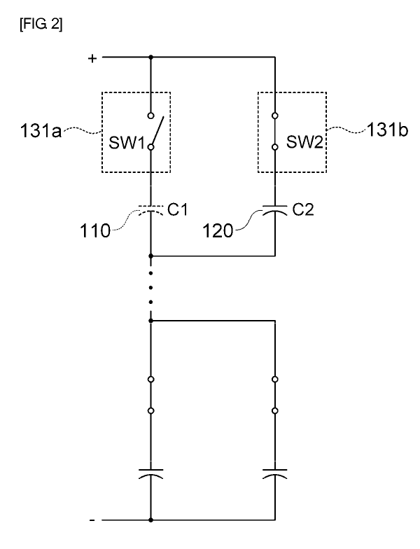

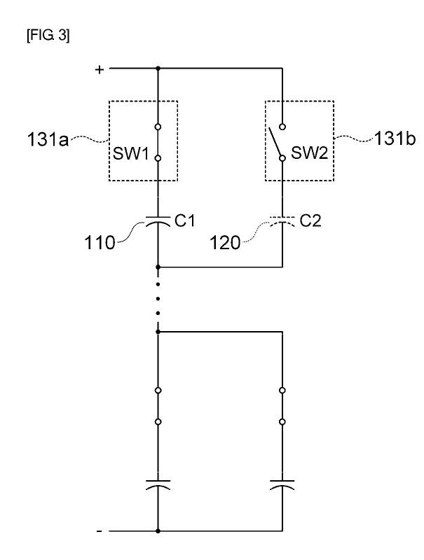

FIGS. 2 and 3 are diagrams for explaining the operation of the switch for selectively opening the energy containers corresponding to the deterioration conditions in the energy storage module according to the exemplary embodiment of the present invention.

Referring to FIGS. 2 and 3, in the exemplary embodiment of the present invention, a method of using temperature so as to determine whether the energy container corresponds to the deterioration conditions will be described as an example.

First, the first and second energy containers 110 and 120 perform the charging/discharging by maintaining the normal connected state and the switching control unit 130 senses the temperature of the first and second energy containers 110 and 120 to determine whether there is the energy container reaching the first reference temperature among the first and second energy containers 110 and 120.

As shown in FIG. 2, if the first energy container 110 reaches the first reference temperature, the switching control unit 130 turns-off the first switch 131a (SW1) so as to open the first energy container 110 and maintains the connection of the second energy container 120. Therefore, the charging/discharging is performed only in the second energy container 120.

As described above, when the charging/discharging is performed only in the second energy container 120 and then, the temperature of the second energy container 120 rises to the second reference temperature higher than the first reference temperature, the switching control unit 130 turns-off the second switch 131b (SW2) so as to open the second energy container 120 and turns-on the first switch 131a (SWI) so as to again connect the first energy container 110, as shown in FIG. 3. Therefore, the charging/discharging is performed only in the first energy container 110.

In this case, the first reference temperature means a minimum temperature so as to sense the deterioration and the second reference temperature means a maximum temperature that does not cause the deterioration. For example, when the temperature in a state where the first and second energy containers 110 and 120 are normally operated without being deteriorated is below 35° C., the first reference temperature means appropriately 35° C. or more and below 55° C. and the second reference temperature means approximately 55° C. or more and below 60° C. In this case, it is assumed that 60° C. is temperature causing deterioration.

Further, when the temperature of the first and second energy containers 110 and 120 is below the first reference temperature, the switching control unit 130 connects both of the first and second energy containers 110 and 120 to perform the charging/discharging in the first and second energy containers 110 and 120.

As described above, the deterioration may be minimized without stopping the overall energy storage module by selectively charging/discharging the energy container by selectively opening the energy container corresponding to the deterioration conditions.

Meanwhile, in the exemplary embodiment of the present invention, the case of high temperature as the condition of causing the deterioration is described as an example. However, the exemplary embodiment of the present invention may similarly operate even at the low temperature as described above.

Hereinafter, a process of controlling the energy storage module according to the exemplary embodiment of the present invention will be described.

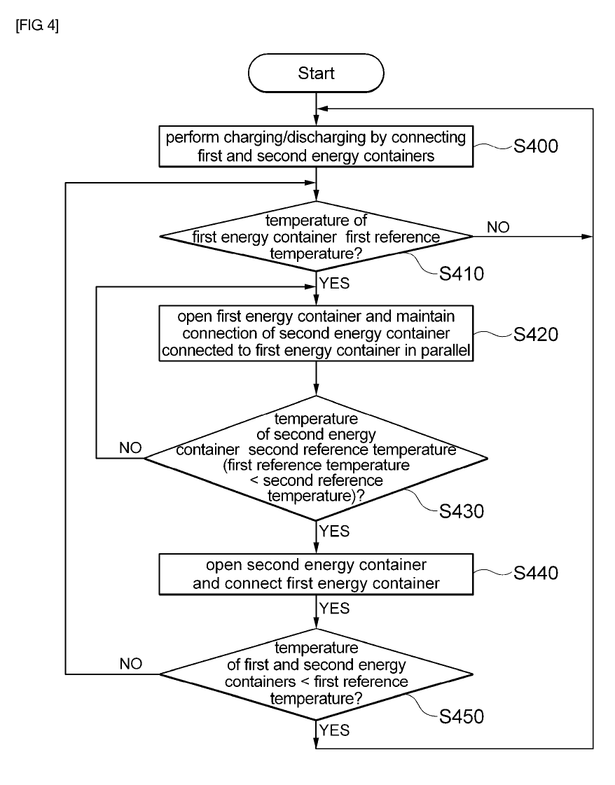

FIG. 4 is an operational flow chart for describing a process of controlling the energy storage module according to the exemplary embodiment of the present invention. As shown in FIG. 4, both of the first and second energy containers 110 and 120 perform the charging/discharging while maintaining the normal connection state (S400).

In this case, the switching control unit 130 senses the energy container reaching the predetermined first reference temperature among the first and second energy containers 110 and 120 (S410). That is, the switching control unit 130 determines whether the temperature of the first and second energy containers 110 and 120 is the first reference temperature or more. If it is determined that the temperature of the first energy container 110 reaches the first reference temperature, the switching control unit 130 opens the first energy container 110 and maintains the connection of the second energy container 120 (S420).

In this case, the first reference temperature means a minimum temperature so as to sense the deterioration and the second reference temperature means a maximum temperature that does not cause the deterioration.

Next, the switching control unit 130 determines whether the second energy container 120 connected to the first energy container 110 reaching the first reference temperature in parallel reaches the second reference temperature (S430).

At step 430, when the second energy container reaches the second reference temperature, the switching control unit 130 opens the second energy container 120 and again connects the first energy container 110.

Further, the switching control unit 130 determines whether the temperature of both of the first and second energy containers 110 and 120 is below the first reference temperature (S450). If it is determined that the temperature of the first and second energy containers 110 and 120 is below the first reference temperature, the switching control unit 130 connects both of the first and second energy containers 110 and 120 to perform the charging/discharging in the first and second energy containers 110 and 120 (S400).

As described above, the deterioration of the energy storage module may be minimized by selectively opening the first and second energy containers 110 and 120, every time the temperature of both of the first and second energy containers 110 and 120 sequentially reaches the first and second reference temperature for sensing the deterioration by continuously sensing the temperature of the first and second energy containers 110 and 120. As a result, the exemplary embodiment of the present invention can improve the reliability of the energy storage module.

As described above, the energy storage module and the controlling method thereof according to the exemplary embodiment of the present invention can minimize the deterioration without stopping the overall energy storage module by connecting the plurality of energy containers in parallel and selectively charging/discharging the energy container by selectively opening the energy containers corresponding to the deterioration conditions.

In detail, the exemplary embodiment of the present invention can normally operate the overall energy storage module while minimizing the deterioration without stopping the overall energy storage module or controlling the voltage and current of the energy container by opening the energy container corresponding to the deterioration conditions and selectively performing the operation of connecting the energy containers in parallel when the energy containers corresponding to the deterioration conditions are sensed by continuously monitoring the state of the energy containers.

As a result, the exemplary embodiment of the present invention can improve the reliability of the overall energy storage module.

While the present invention has been shown and described in connection with the exemplary embodiments, it will be apparent to those skilled in the art that modifications and variations can be made without departing from the spirit and scope of the invention as defined by the appended claims.

1-20. (canceled)

21. An energy storage module, comprising:
a first energy container;
a second energy container that is connected to the first energy container in parallel;
a switching control unit that senses the energy containers corresponding to predetermined deterioration conditions among the first and second energy containers to selectively open the energy containers corresponding to deterioration conditions so as to selectively charge/discharge the energy containers.

22. The energy storage module according to claim 21, wherein the deterioration conditions include first and second deterioration conditions sequentially set according to temperature.

23. The energy storage module according to claim 21, wherein the deterioration conditions include first and second deterioration conditions sequentially set according to voltage.

24. The energy storage module according to claim 21, wherein the deterioration conditions include first and second deterioration conditions sequentially set according to a frequency of charging/discharging.

25. The energy storage module according to claim 22, wherein the switching control unit senses the first energy container corresponding to the first deterioration condition among the first and second energy containers to open the first energy container corresponding to the first deterioration condition and connect the second energy container.

26. The energy storage module according to claim 23, wherein the switching control unit senses the first energy container corresponding to the first deterioration condition among the first and second energy containers to open the first energy container corresponding to the first deterioration condition and connect the second energy container.

27. The energy storage module according to claim 24, wherein the switching control unit senses the first energy container corresponding to the first deterioration condition among the first and second energy containers to, open the first energy container corresponding to the first deterioration condition and connect the second energy container.

28. The energy storage module according to claim 25, wherein the switching control unit senses whether the second energy container corresponds to the second deterioration condition and if it is determined that the second energy container corresponds to the second deterioration condition, opens the second energy container and connects the first energy container.

29. The energy storage module according to claim 21, wherein the switching control unit connects both of the first and second energy containers if it is determined that the first and second energy containers do not correspond to the deterioration conditions.

30. The energy storage module according to claim 22, wherein the first deterioration condition is a first reference temperature that is a minimum temperature for sensing the deterioration, and
the second deterioration condition is a second reference temperature that is a maximum temperature not causing the deterioration.

31. The energy storage module according to claim 21, wherein the switching control unit includes:
a first switch that is connected to the first energy container in series; and
a second switch that is connected to the second energy container in series.

32. The energy storage module according to claim 21, wherein the switching control unit includes a controller that senses the energy container corresponding to the deterioration conditions among the first and second energy containers and outputs a control signal for selectively opening the energy container corresponding to the deterioration conditions.

33. The energy storage module according to claim 21, wherein the first energy container is configured in at least one that is connected in series.

34. The energy storage module according to claim 33, wherein the second energy container is connected to the first energy container in parallel and is configured in at least one.

35. A controlling method of an energy storage module including a first energy container and a second energy container connected to the first energy container in parallel, comprising:
sensing the energy container corresponding to predetermined determination conditions among the first and second energy containers that perform charging/discharging; and
selectively opening the energy container corresponding to the deterioration conditions so as to selectively charge/discharge the energy containers.

36. The controlling method of an energy storage module according to claim 35, wherein the deterioration conditions include first and second deterioration conditions sequentially set according to temperature

37. The controlling method of an energy storage module according to claim 36, wherein the sensing includes a first sensing step that senses the first energy container corresponding to the first deterioration condition among the first and second energy containers, and
the opening includes a first opening step that opens the first energy container corresponding to the first deterioration condition and connects the second energy container.

38. The controlling method of an energy storage module according to claim 37, wherein the sensing further includes a second sensing step that senses whether the second energy container corresponds to the second deterioration condition, and
the opening further includes a second opening step that opens the second energy container and connects the first energy container if it is determined that the second energy container corresponds to the second deterioration condition.

39. The controlling method of an energy storage module according to claim 35, further comprising connecting both of the first and second energy containers if it is determined that the first and second energy containers do not correspond to the deterioration conditions.
